(19) United States
(12) Patent Application Publication
(10) Pub. No.: US 2014/0379510 A1
(43) Pub. Date: Dec. 25, 2014

(54) AUCTION APPARATUS, AUCTION METHOD, STORAGE MEDIUM, AND AUCTION SYSTEM

(71) Applicant: YAHOO JAPAN CORPORATION, Tokyo (JP)

(72) Inventors: Takehiro KISHI, Tokyo (JP); Yoshiaki WATANABE, Tokyo (JP); Noburo MINAKATA, Tokyo (JP)

(21) Appl. No.: 14/302,904

(22) Filed: Jun. 12, 2014

(30) Foreign Application Priority Data
Jun. 19, 2013 (JP) 2013-129048

(51) Int. Cl. G06Q 30/08

(52) U.S. Cl. CPC G06Q 30/08
USPC 705/26.3

(57) ABSTRACT

An auction apparatus includes a reception unit, an item information obtaining unit, a selling information generation unit, and an auction execution unit. The reception unit receives selling request including item ID and user ID. The item information obtaining unit obtains item information corresponding to the user ID and the item ID included in the received selling request from a kept item management apparatus storing item information associated with the item ID and the user ID when the reception unit receives the selling request. The selling information generation unit generates selling information including information required in an auction for selling using the item information obtained by the item information obtaining unit in response to the selling request. The auction execution unit executes the auction using the generated selling information.

### CROSS-REFERENCE TO RELATED APPLICATIONS

The present application claims priority to and incorporates by reference the entire contents of Japanese Patent Application No. 2013-129048 filed in Japan on Jun. 19, 2013.

### BACKGROUND OF THE INVENTION

1. Field of the Invention

The present invention relates to an auction apparatus, an auction method, a storage medium, and an auction system.

2. Description of the Related Art

In recent years, with the rapid spread of the Internet, products are widely traded by individual people on web sites. For example, Japanese Laid-open Patent Publication No 2001-216444 discloses an auction system for trading products between individual people in an auction format. With the recent advancement of information communication equipment, users can sell and bid in an auction using portable information communication equipment.

However, in order to sell in an auction, a seller has to perform several works. For example, the seller has to take a picture of a product which is to be sold, search the official name and information about the manufacturer, the model number, and the like, and register the information as selling information. However, such work is difficult for a user who has never sold in any auction before, and it is troublesome to do such work, and therefore, this may be a heavy burden for the user.

When the burden of the selling work is heavy, an owner of an item may dispose of the item without selling the item in the auction even if the item is no longer necessary. When the item is disposed of even though there is another person who wants that item, this means losing of the chance of effective use of resources by means of reuse of the item.

Accordingly, this invention is made to solve the above problem associated with the conventional technique, and it is an object of this invention to reduce the user's burden associated with the selling work in an auction.

### SUMMARY OF THE INVENTION

It is an object of the present invention to at least partially solve the problems in the conventional technology.

In order to solve the above-described problems, an auction apparatus according to an exemplary aspect of the present invention includes a reception unit, an item information obtaining unit, a selling information generation unit, and an auction execution unit. The reception unit receives selling request including identification information about an item and identification information about a user who sells the item from an outside the auction apparatus. The item information obtaining unit obtains item information about an item which is owned by a user identified by the identification information included in the received selling request and which is identified by the identification information included in the received selling request from an external database when the reception unit receives the selling request. The external database is provided outside the auction apparatus and manages, for each user, item information about an item owned by the user. The selling information generation unit generates selling information including information required in an auction for selling using the item information obtained by the item information obtaining unit in response to the selling request. The auction execution unit executes the auction using the generated selling information.

An auction method according to another exemplary aspect of the present invention for causing a computer to execute: receiving selling request including identification information about an item and identification information about a user who sells the item from an outside the computer; obtaining, upon receiving the selling request, item information about an item which is owned by a user identified by the identification information included in the received selling request and which is identified by the identification information included in the received selling request from an external database which is provided outside the computer and which manages, for each user, item information about an item owned by the user; generating selling information including information required in an auction for selling using item information obtained in response to the selling request; and executing the auction using the generated selling information.

A non-transitory computer readable storage medium having stored therein a program according to another exemplary aspect of the present invention causing a computer to execute a process, the process comprising: receiving selling request including identification information about an item and identification information about a user who sells the item from an outside the computer; obtaining, upon receiving the selling request, item information about an item which is owned by a user identified by the identification information included in the received selling request and which is identified by the identification information included in the received selling request from an external database which is provided outside the computer and which manages, for each user, item information about an item owned by the user; generating selling information including information required in an auction for selling using item information obtained in response to the selling request; and executing the auction using the generated selling information.

An auction system according to another exemplary aspect of the present invention includes an auction apparatus and a kept item management apparatus. The kept item management apparatus includes a selling request transmission unit, an item information storage unit, and an item information transmission unit. The selling request transmission unit transmits, upon receiving, from a user, a selling request including identification information about an item and identification information about the user, the received selling request to the auction apparatus. The item information storage unit stores, for each user, item information about an item which is owned by the user and which is deposited from the user and held in a warehouse. The item information transmission unit obtains, upon receiving an item information request including identification information about an item and identification information about the user from the auction apparatus, item information about an item which is owned by a user identified by the identification information included in the item information request and which is identified by the identification information included in the item information request and transmits the obtained item information as well as the identification information about the item and the user included in the item information request to the auction apparatus. The auction apparatus includes a reception unit, an item information obtaining unit, a selling information generation unit, and an auction execution unit. The reception unit receives the selling request from the kept item management apparatus. The item information obtaining unit transmit the item information request including the identification information about the item and the identification information about the user included in the selling request to the kept item management apparatus when the reception unit receives the selling request, and obtains item information about an item identified by the identification information included in the selling request as a response to the item information request from the kept item management apparatus. The selling information generation unit generates selling information including information required in an auction for selling using item information obtained by the item information obtaining unit in response to the selling request. The auction execution unit executes the auction using the generated selling information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram for explaining an example of overview of processing in a first embodiment;

FIG. 2 is a system configuration diagram illustrating an example of an auction system according to the embodiment of the present invention;

FIG. 3 is a block diagram illustrating an example of a functional configuration of a kept item management apparatus;

FIG. 4 is a figure illustrating an example of a structure of data stored in an item information storage unit;

FIG. 5 is a figure illustrating an example of an item management screen generated by a management screen generation unit according to the first embodiment;

FIG. 6 is a figure illustrating an example of a functional configuration of an auction apparatus according to the first embodiment;

FIG. 7 is a figure illustrating an example of a selling screen generated by a selling information generation unit;

FIG. 8 is a figure illustrating an example of a structure of data stored in the selling information storage unit;

FIG. 9 is a sequence diagram illustrating an example of operation of the auction system according the first embodiment;

FIG. 10 is a conceptual diagram for explaining an example of overview of processing according to a second embodiment;

FIG. 11 is a figure illustrating an example of an item management screen generated by a management screen generation unit according to the second embodiment;

FIG. 12 is a block diagram illustrating an example of a functional configuration of the auction apparatus according to the second embodiment;

FIG. 13 is a figure illustrating an example of a structure of data stored in a desired item information storage unit;

FIG. 14 is a figure illustrating an example of a disclosure screen generated by a disclosure information generation unit;

FIG. 15 is a figure illustrating an example of a structure of data stored in a disclosure information storage unit;

FIG. 16 is a sequence diagram illustrating an example of operation of the auction system according to the second embodiment;

FIG. 17 is a conceptual diagram for explaining an example of concept of processing according to a third embodiment;

FIG. 18 is a block diagram illustrating an example of a functional configuration of an auction apparatus according to the third embodiment;

FIG. 19 is a sequence diagram illustrating an example of operation of the auction system according to the third embodiment; and

FIG. 20 is a hardware configuration diagram illustrating an example of a computer achieving functions of the auction apparatus.

### DETAILED DESCRIPTION OF THE PREFERRED EMBODIMENTS

### First Embodiment

First, the first embodiment according to the present invention will be explained with reference to drawings.

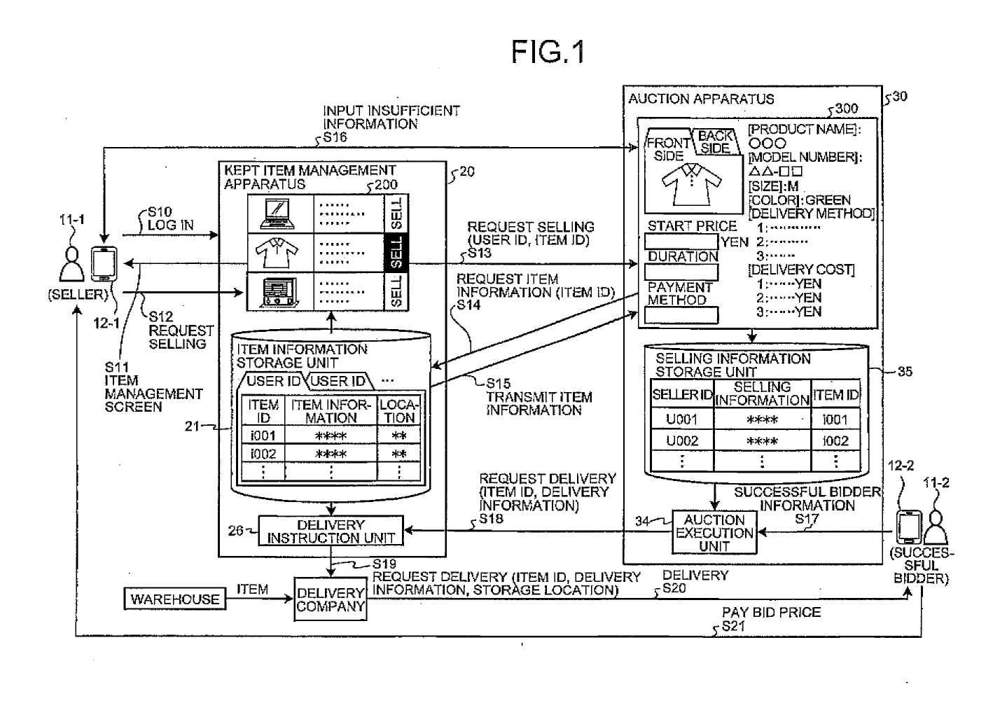

FIG. 1 is a conceptual diagram for explaining an example of concept of processing according to the first embodiment. As a presumption of the present embodiment, it is supposed that a user 11-1 who is a seller deposits one or more owned items with a warehouse managed by a warehouse company.

In a system of the warehouse company, a kept item management apparatus 20 is provided to manage items deposited by the user. The kept item management apparatus 20 is provided with an item information storage unit 21 that stores, for each user, item information indicating information about each item deposited by the user and information about a storage location thereof.

The item information includes information about an image, a product name, a model number, a color, a size, and the like of an item in question. Such information may be prepared and registered by the user who deposited the item, or the warehouse company may collect information about the deposited item from a manufacturer's site of the item and the like.

The user 11-1 who is the seller is registered with the kept item management apparatus 20 as a user who deposits the item with the warehouse.

First, the user 11-1 logs in to the kept item management apparatus 20 using an information terminal 12-1 such as a smartphone, a cellular phone, a PDA (Personal Digital Assistant), and a PC (Personal Computer) (S10).

The kept item management apparatus 20 authenticates the user 12-1, and obtains the item information of each item associated with the user ID of the user 11-1 from the item information storage unit 21. Then, the kept item management apparatus 20 generates, for each of the items, an item management screen 200 in which the item information and the selling button are associated, and transmits it to the information terminal 12-1 of the user 11-1 (S11).

The user 11-1 refers to the item management screen 200 displayed on the information terminal 12-1, and manages the items owned. Then, when there is an item in the displayed item management screen 200 which the user 1-1 wants to sell in the auction, the user 11-1 operates the information terminal 12-1, and selects a selling button associated with the item. When the selling button is selected, the information terminal 12-1 transmits a selling request including the item ID of the item associated with the selected selling button to the kept item management apparatus 20 (S12).

When the kept item management apparatus 20 receives the selling request from the information terminal 12-1, the kept item management apparatus 20 generates a selling request including the item ID included in the selling request and the user ID of the user 11-1 of the information terminal 12-1, and transmits the generated selling request to an auction apparatus 30 (S13). Thereafter, the service received by the user proceeds from the warehouse company service provided by the kept item management apparatus 20 to the auction service provided by the auction apparatus 30.

In the present embodiment, the kept item management apparatus 20 and the auction apparatus 30 are associated by the ID, and when the user successfully logs in to one of the apparatuses, the user can receive the service without log in to the other of the apparatuses again.

When the auction apparatus 30 receives the selling request from the kept item management apparatus 20, the auction apparatus 30 obtains the item ID from the selling request, and generates an item information request including the obtained item ID and transmits the item information request to the kept item management apparatus 20 (S14).

When the kept item management apparatus 20 receives the item information request from the auction apparatus 30, the kept item management apparatus 20 obtains the item information associated with the item ID included in the item request from the item information storage unit 21. Then, the kept item management apparatus 20 transmits the obtained item information to the auction apparatus 30 (S15).

The auction apparatus 30 stores, in advance, a template defining the items of the selling information required in the auction for selling. The auction apparatus 30 extracts information required for each item in the template from among the item information received from the kept item management apparatus 20, and sets the information in the corresponding item, thus generating the selling information automatically.

The warehouse company service is for the purpose of having users deposit items therewith, and therefore, information required in the auction for selling for example, information such as “start price” and “duration” of the auction) is usually not included in the item information in the item information storage unit 21 of the kept item management apparatus 20. Therefore, the auction apparatus 30 automatically generates the selling information upon setting all the items that can be set based on the item information given by the kept item management apparatus 20 while leaving the items such as “start price” as blanks.

Then, the auction apparatus 30 generates a selling screen 300 including the generated selling information. Then, the auction apparatus 30 transmits the data of the selling screen 300 thus generated to the information terminal 12-1 of the user 11-1, thus requesting the users 11-1 to input insufficient information (S16). In this case, the user 11-1 may delete information not required for selling from the selling information.

After the user 11-1 complements insufficient information, the auction apparatus 30 associates the selling information with the user ID and the item ID, and stores the selling information in a selling information storage unit 35. Then, an auction execution unit 34 discloses the selling information stored in the selling information storage unit 35 on an auction site to a member, thus executing an auction.

Then, when a user 11-2 who is a bidder wins the sold item by operating an information terminal 12-2, the user 11-2 uses the information terminal 12-2 to transmit successful bidder information including information for distinguishing the successful bidder, information indicating a shipping destination of the item that has been won, and the like to the auction execution unit 34 (S17).

The auction execution unit 34 extracts the item ID of the item that the user has won and delivery information including information about shipping destination of the item, a contact information of the bidder, and the like from the received successful bidder information. Then, the auction execution unit 34 generates a delivery request including the extracted item ID and delivery information, and transmits the generated delivery request to the kept item management apparatus 20 (S18).

When a delivery instruction unit 26 in the kept item management apparatus 20 receives the delivery request, the delivery instruction unit 26 refers to the item information storage unit 21 to identify information about the storage location associated with the item ID included in the delivery request. Then, the delivery instruction unit 26 incorporates the identified information about the storage location into the delivery request to transmit the delivery request to a server of the delivery company (S19).

The delivery company collects the item corresponding to the item ID included in the delivery request from the warehouse of the storage location corresponding to the information included in the delivery request received by the server. Then, the delivery company delivers the collected item to the shipping destination included in the delivery request (S20).

The user 11-2 who is the bidder pays the bid price to the user 11-1 who is the seller (S21). After the bid price is paid to the user 11-1 who is the seller from the user 11-2 who is the bidder, the delivery company may deliver the item which has been won by the user 11-2.

As described above, when the warehouse company manages, in a database, detailed information about the image of the deposited item, the model number, and the like, the user 11-1 can easily generate, through simple operation, the selling information, which is required in the auction for selling, about the item deposited with the warehouse company. Therefore, the burden imposed on the seller in the auction for selling is reduced, and effective use of resources in the auction is promoted.

In many cases, the warehouse company provides a service for delivering a deposited item to a location designated by the owner of the item via the delivery company when the owner needs the item. Therefore, when the seller requests the warehouse company to deliver the item to the bidder, the seller can have the warehouse company do works such as packing the sold item and arrange the delivery to the shipping destination designated by the bidder with the delivery company, and thus the work of the seller can be done by the warehouse company on behalf of the seller. For the warehouse company, this can be done by simply changing the shipping destination of the deposited item, and therefore, no additional work is carried out by the warehouse company.

The bidder has to inform the seller of information about the shipping destination of the item that the bidder has won and the contact information, but in a case where the shipping destination is the home and the like, the bidder may hesitate to inform a general seller of private information such as the home address and the telephone number. However, when the auction system according to the present embodiment is employed, the private information of the bidder is not notified to the seller but is notified to the warehouse company. Therefore, even a user who hesitates to inform the private information can participate in the auction, and thus, the number of people who participate in the auction is expected to increase.

Detailed configuration for achieving the mechanism described above will be hereinafter explained.

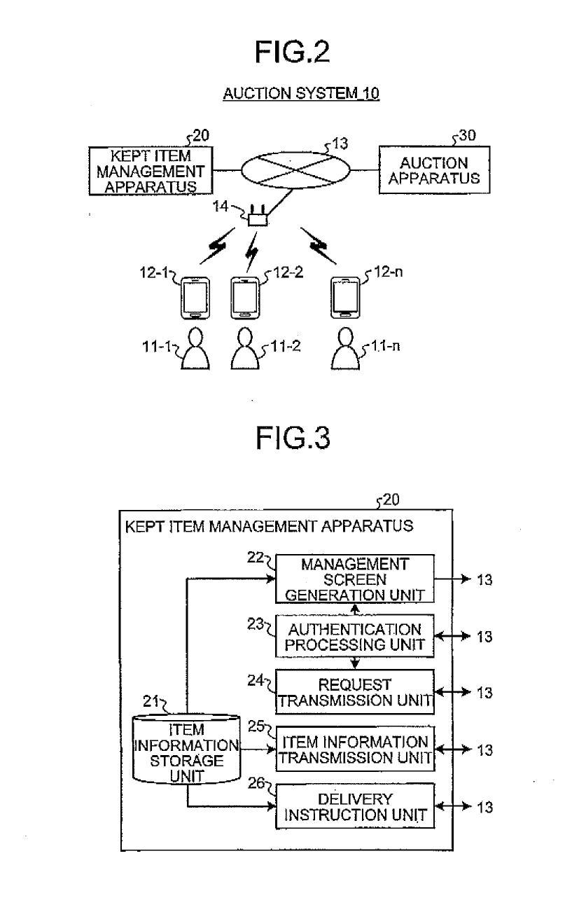

FIG. 2 is a system configuration diagram illustrating an example of an auction system 10 according to the embodiment of the present invention. The auction system 10 includes the kept item management apparatus 20 and the auction apparatus 30. The kept item management apparatus 20 and the auction apparatus 30 are communicatively connected to a communication line 13.

The information terminals 12-1 to n operated by the users 11-1 to n, respectively, communicate wirelessly with a cell site 14, and communicate with the kept item management apparatus 20 or the auction apparatus 30 via the cell site 14 and the communication line 13.

FIG. 3 is a block diagram illustrating an example of a functional configuration of the kept item management apparatus 20. The kept item management apparatus 20 includes an item information storage unit 21, a management screen generation unit 22, an authentication processing unit 23, a request transmission unit 24, an item information transmission unit 25, and a delivery instruction unit 26.

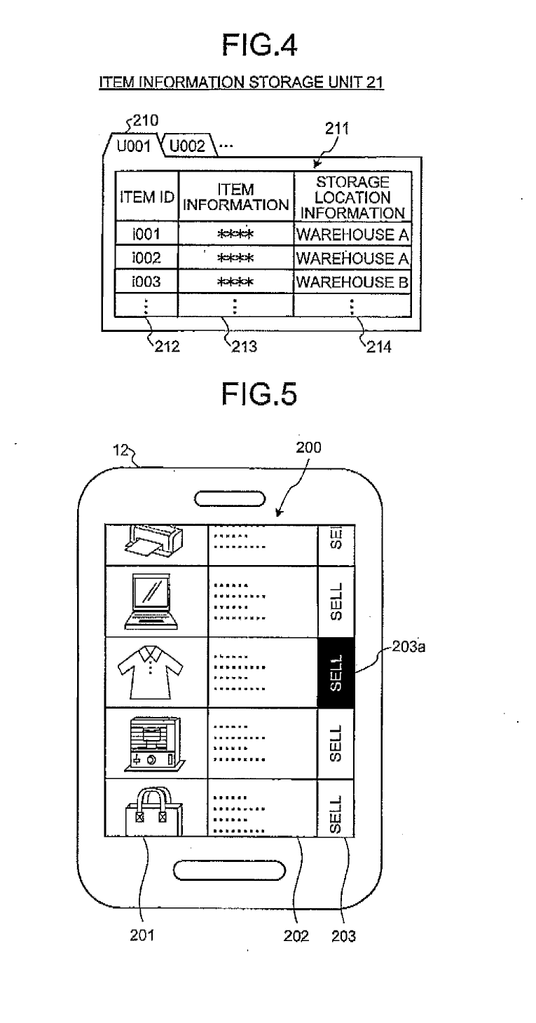

FIG. 4 illustrates an example of a structure of data stored in the item information storage unit 21. The item information storage unit 21 stores an item table 211 for each user ID 210 distinguishing each user. Each item table 211 stores, in association with an item ID 212 identifying each item deposited with the warehouse company by the user identified by the user ID 210, item information 213 about the item in question aid storage location information 214 about the item in question.

The item information 213 includes, for example, information about an image, a product name, a model number, a color, a size of the corresponding item, the state of the item, a remark, and the like. The remark includes appended information about each item, for example, the time when the item was purchased, the price when the item was purchased, how the item was obtained (information about, e.g., a present given by whom), and the like. The remark may include private information that can only be known by the owner of the item.

The image of each item may be prepared by the user who deposited the item and registered with the item information storage unit 21, or the warehouse company may take a picture of the deposited item and register the picture. In addition, the information such as the product name and the model number of each item may also be prepared by the user who deposited the item and registered with the item information storage unit 21, or the warehouse company may obtain the information such as the product name and the model number of each item from a site of the manufacturer of the item and the like, on the basis of a bar code attached to the item, identification information, or the like, and may register the information with the item information storage unit 21.

In the item information storage unit 21 for example as shown in FIG. 4, for example, an item table 211 is associated with a user ID 210 “U001”, and in the item table 211, for example, item information 213 “****” and storage location information 214 “warehouse a” are associated with an item ID 212 “i001”.

Back to FIG. 3, explanation will be continued. When the authentication processing unit 23 receives an authentication request from the information terminal 12 via the communication line 13, the authentication processing unit 23 authenticates the user 11 of the information terminal 12. Then, when the authentication processing unit 23 successfully authenticates the user 11, then the user ID of the user 11 is transmitted to the management screen generation unit 22 and the request transmission unit 24. When the authentication processing unit 23 successfully authenticates the user 11, the ID of the user who is successfully authenticated is shared with the auction apparatus 30.

When the management screen generation unit 22 receives the user ID from the authentication processing unit 23, the management screen generation unit 22 identifies the item table 211 associated with the user ID by referring to the item information storage unit 21 on the basis of the received user ID. Then, the authentication processing unit 23 refers to the identified item table 211 to extract the item information for each item ID, and generates the item management screen 200 as shown in FIG. 5, for example. Then, the management screen generation unit 22 transmits data of the generated item management screen 200 to the information terminal 12 via the communication line 13.

FIG. 5 illustrates an example of the item management screen 200 generated by the management screen generation unit 22 in the first embodiment. For example, as shown in FIG. 5, the item management screen 200 includes, for each item corresponding to an item ID, an image 201 of the item in question, detailed information 202 about the item, and a selling button 203. FIG. 5 shows an example where the item management screen 200 is displayed in the information terminal 12.

While the information terminal 12 is displaying the item management screen 200, the user 11 of the information terminal 12 operates the information terminal 12 and selects a selling button 203 of any one of the items (for example, a selling button 203a). In this case, the information terminal 12 transmits a selling request, which includes the item ID associated with the selling button 203, to the kept item management apparatus 20 via the communication line 13.

When the request transmission unit 24 receives the selling request from the information terminal 12, the user ID received from the authentication processing unit 23 is incorporated into the received selling request. Then, the request transmission unit 24 transmits the selling request including the user ID and the item ID to the auction apparatus 30 via the communication line 13.

When the item information transmission unit 25 receives the item information request including the item ID from the auction apparatus 30 via the communication line 13, the item information transmission unit 25 refers to the item information storage unit 21 on the basis of the item ID, and extracts the item information associated with the item ID. Then, the item information transmission unit 25 transmits the extracted item information via the communication line 13 to the auction apparatus 30.

When the delivery instruction unit 26 receives the delivery request including the item ID and the delivery information from the auction apparatus 30 via the communication line 13, the delivery instruction unit 26 refers to the item information storage unit 21 on the basis of the item ID, and extracts information about the storage location associated with the item ID. Then, the delivery instruction unit 26 incorporates information about the extracted storage location into the delivery request, and transmits the delivery request including the item ID, the delivery information, and information about the storage location to the server of the delivery company via the communication line 13.

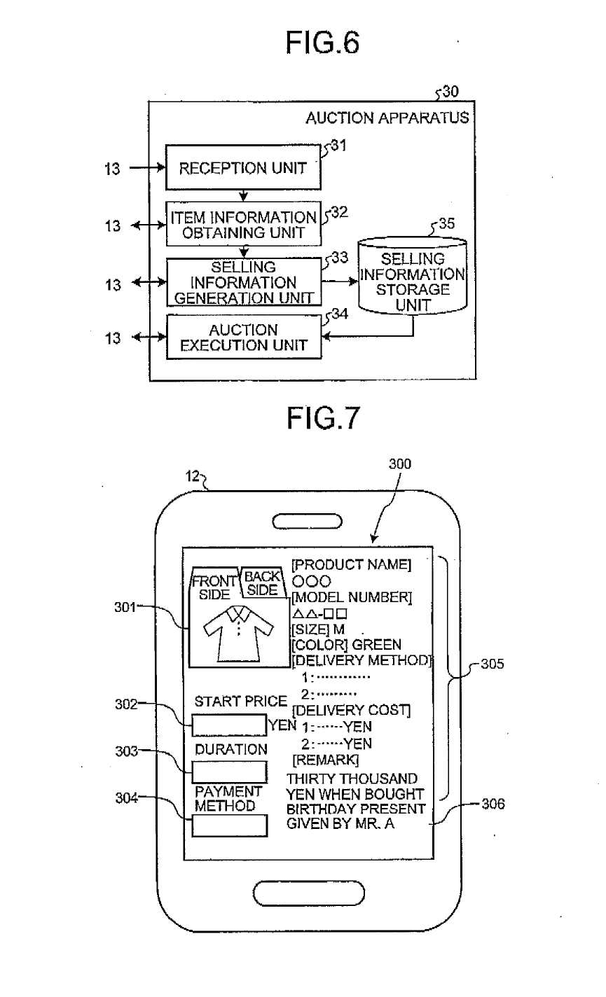

FIG. 6 illustrates an example of a functional configuration of the auction apparatus 30 according to the first embodiment. The auction apparatus 30 according to the present embodiment includes a reception unit 31, an item information obtaining unit 32, a selling information generation unit 33, an auction execution unit 34, and a selling information storage unit 35.

When the reception unit 31 receives the selling request from the kept item management apparatus 20 via the communication line 13, the reception unit 31 extracts the user ID and the item ID from the received selling request, and transmits the user ID and the item ID thus extracted to the item information obtaining unit 32.

When the item information obtaining unit 32 receives the user ID and the item ID from the reception unit 31, the item information obtaining unit 32 generates an item information request including the item ID in question and transmits the generated item information request to the kept item management apparatus 20 via the communication line 13. Then, when the item information is received from the kept item management apparatus 20, the item information obtaining unit 32 transmits the received item information as well as the user ID and the item ID to the selling information generation unit 33.

The selling information generation unit 33 holds, in advance, a template having items of information which are to be included in the selling information. When the user ID, the item ID, and the item information are received from the item information obtaining unit 32, the selling information generation unit 33 extracts information for setting in each item in the template from the received item information, and sets the information in the corresponding items, thus generating the selling information.

Then, the selling information generation unit 33 generates a selling screen including the generated selling information. Then, the selling information generation unit 33 transmits the data of the generated selling screen via the communication line 13 to the information terminal 12 of the user 11 corresponding to the user ID received from the item information obtaining unit 32. FIG. 7 illustrates an example of the selling screen 300 generated by the selling information generation unit 33. For example, FIG. 7 illustrates a state where the selling screen 300 is displayed on the information terminal 12.

For example, as shown in FIG. 7, the selling screen 300 includes an area 301 displaying an image of an item, an area 302 displaying a start price of an auction, an area 303 displaying a duration of the auction, an area 304 displaying a payment method in a case where the item was won, and an area 305 displaying detailed information about an item sold.

The image of the item displayed in the area 301 and the detailed information displayed in the area 305 are extracted from the item information obtained by the item information obtaining unit 32. The detailed information about the item displayed in the area 305 includes information about a delivery method and a delivery cost, but the information is, for example, information in a case where the warehouse company requests the delivery company to deliver the item, and is information registered in advance in the kept item management apparatus 20. The detailed information about the item displayed in the area 305 may include private information, which is known to only the owner of the item, like the information displayed in the area 306, for example.

The information displayed in the areas 302 to 304 is information unique to the auction, and when the item is deposited with the warehouse company, the information displayed in the areas 302 to 304 is information that is not set in the item information storage unit 21 in the kept item management apparatus 20. Therefore, the selling information generation unit 33 leaves the areas 302 to 304 as blank, and generates the selling screen 300. The selling information generation unit 33 transmits the generated selling screen 300 to the information terminal 12 to display the selling screen 300 on the information terminal 12, so that the user 11 of the information terminal 12 is requested to complement information which is insufficient in executing the auction.

In the selling screen 300 displayed on the screen of the information terminal 12, the user 11 of the information terminal 12 operates the information terminal 12 to input necessary information into the vacant areas 302 to 304 and complement information which is insufficient in the area 305. Then, the information terminal 12 transmits data of the selling screen 300, in which insufficient information has been complemented and unnecessary information has been deleted, to the kept item management apparatus 20 via the communication line 13.

When the selling information generation unit 33 receives, from the information terminal 12, the data of the selling screen 300 in which insufficient information has been complemented and unnecessary information has been deleted, the selling information generation unit 33 extracts the selling information from the received selling screen 300, and stores the extracted selling information to the selling information storage unit 35.

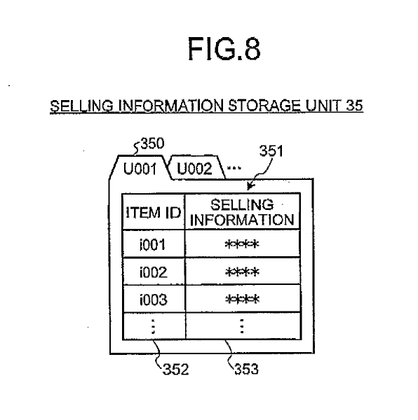

FIG. 8 illustrates an example of a structure of data stored in the selling information storage unit 35. For example, as shown in FIG. 8, the selling information storage unit 35 stores a selling table 351 for each user ID 350 identifying each user 11 who is a seller. Each selling table 351 stores selling information 353 of an item in question for each item ID 352 identifying the item sold by the user 11 corresponding to the user ID 350.

When the selling information generation unit 33 receives, from the information terminal 12, the data of the selling screen 300 in which insufficient information has been complemented and unnecessary information has been deleted, the selling information generation unit 33 identifies, in the selling information storage unit 35, the selling table 351 associated with the user ID of the user 11 of the information terminal 12. Then, the selling information generation unit 33 stores, into the identified selling table 351, the selling information which is included in the received selling screen 300 and in which insufficient information has been complemented and unnecessary information has been deleted by the user 11 of the information terminal 12 in association with the item ID received from the item information obtaining unit 32.

The auction execution unit 34 discloses the selling information for each item ID stored in the selling information storage unit 35 to the members of the auction, thus executing the auction. It should be noted that the auction execution unit 34 may disclose the selling information in the selling information storage unit 35 to the users 11 other than the members of the auction. However, in this case, although the users 11 other than the members of the auction can view the selling information, but the users 11 other than the members of the auction cannot bid in the auction.

When a sold item is won, the auction execution unit 34 receives, from the information terminal 12 of the bidder, the successful bidder information including the item ID of the item that the bidder has won and the delivery information about the shipping destination of the item and the contact information of the bidder. Then, the auction execution unit 34 extracts the item ID and the delivery information from the received successful bidder information, and transmits the delivery request including the item ID and the delivery information thus extracted to the kept item management apparatus 20 via the communication line 13.

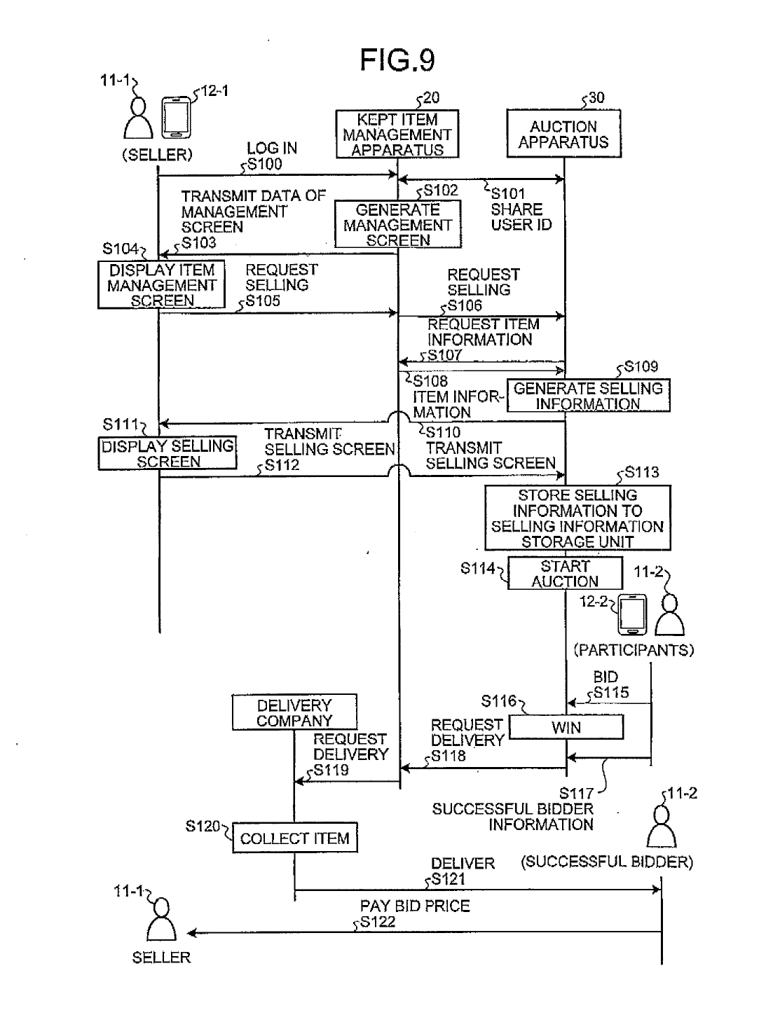

Subsequently, overall operation of the auction system 10 in the present embodiment will be explained with reference to FIG. 9. FIG. 9 is a sequence diagram illustrating an example of operation of the auction system 10 according to the first embodiment.

First, the user 11-1 who is the seller operates the information terminal 12-1 and logs in to the kept item management apparatus 20 (S100). When the authentication processing unit 23 in the kept item management apparatus 20 successfully authenticates the information terminal 12-1, the authentication processing unit 23 transmits the user ID of the user 11-1 of the information terminal 12-1 to the management screen generation unit 22 and the request transmission unit 24. The authentication processing unit 23 shares the user ID of the user 11-1, who is successfully authenticated, with the auction apparatus 30 (S101).

The management screen generation unit 22 of the kept item management apparatus 20 refers to the item information storage unit 21 on the basis of the user ID received from the authentication processing unit 23, and identifies the item table 211 associated with the user ID. Then, the authentication processing unit 23 refers to the identified item table 211 and extracts the item information for each item ID, and generates, the item management screen 200 explained in FIG. 5, for example (S102). Then, the management screen generation unit 22 transmits data of the generated item management screen 200 to the information terminal 12-1 via the communication line 13 (S103).

The information terminal 12-1 displays the item management screen 200 on the screen on the basis of the data received from the kept item management apparatus 20 (S104). Then, when the information terminal 12-1 receives operation of a selling button from the user 11-1, the information terminal 12-1 transmits the selling request including the item ID associated with the selling button to the kept item management apparatus 20 via the communication line 13 (S105).

Subsequently, the request transmission unit 24 of the kept item management apparatus 20 incorporates the user ID received from the authentication processing unit 23 into the selling request received from the information terminal 12-1. Then the request transmission unit 24 transmits the selling request including the user ID and the item ID to the auction apparatus 30 via the communication line 13 (S106).

Subsequently, the reception unit 31 of the auction apparatus 30 extracts the user ID and the item ID from the selling request received from the kept item management apparatus 20, and sends the user ID and the item ID thus extracted to the item information obtaining unit 32 in the auction apparatus 30. The item information obtaining unit 32 generates an item information request including the item ID received from the reception unit 31, and transmits the generated item information request to the kept item management apparatus 20 via the communication line 13 (S107).

The item information transmission unit 25 in the kept item management apparatus 20 refers to the item information storage unit 21 in the kept item management apparatus 20 on the basis of the item ID included in the received item information request, and extracts the item information associated with, the item ID. Then, the item information transmission unit 25 transmits the extracted item information to the auction apparatus 30 via the communication line 13 (S108).

When the selling request is received from the information terminal 12-1 in step S106, the request transmission unit 24 may cause the item information transmission unit 25 to extract the item information corresponding to the item ID included in the selling request. Then, the request transmission unit 24 may further incorporate the item information extracted by the item information transmission unit 25 into the selling request, and may transmit the selling request including the user ID, the item ID, and the item information to the auction apparatus 30 via the communication line 13. In this case, the item information obtaining unit 32 does not obtain the item information.

Subsequently, the item information obtaining unit 32 of the auction apparatus 30 transmits the item information received from the kept item management apparatus 20 as well as the user ID and the item ID to the selling information generation unit 33. The selling information generation unit 33 extracts information which is to be set in each item in the template of the selling information from the item information received from the item information obtaining unit 32, and generates the selling information by setting the information in the corresponding items (S109).

Subsequently, the selling information generation unit 33 generates the selling screen 300 including the generated selling information. Then, the selling information generation unit 33 transmits the data of the generated selling screen 300 via the communication line 13 to the information terminal 12-1 of the user 11-1 corresponding to the user ID received from the item information obtaining unit 32 (S110). The information terminal 12-1 displays the selling screen 300 on the screen on the basis of the received data (S111).

Subsequently, the user 11-1 of the information terminal 12-1 refers to the selling screen 300 displayed on the screen of the information terminal 12-1 to confirm insufficient information and unnecessary information, and operates the information terminal 12-1 to perform operation for complementing insufficient information and deleting unnecessary information. The information terminal 12-1 transmits the data of the selling screen 300, in which insufficient information has been complemented and unnecessary information has been deleted, to the auction apparatus 30 via the communication line 13 (S112).

Subsequently, the selling information generation unit 33 receives the selling screen 300, in which the insufficient information has been complemented and the unnecessary information has been deleted, from the information terminal 12-1, and identifies, in the selling information storage unit 35, a selling table 351 associated with the user ID of the user 11-1 of the information terminal 12-1. Then, the selling information generation unit 33 stores, into the identified selling table 351, the selling information which is the selling information in the selling screen 300 received and in which the insufficient information has been complemented and the unnecessary information has been deleted by the user 11-1 in such a manner that the selling information is associated with the item ID received from the item information obtaining unit 32 (S113).

Subsequently, the auction execution unit 34 discloses the selling information for each item ID stored in the selling information storage unit 35 to the members of the auction, and executes the auction (S114). The user 11-2 who in a member of the auction operates the information terminal 12-2 to bid in the auction (S115).

When the user 11-2 wins a desired sold object (S116), the user 11-2 operates the information terminal 12-2 to transmit, to the auction apparatus 30, successful bidder information including information about the name of the user 11-2 who has won the item, shipping destination about the item which the user 11-2 has won, and the like (S117). The auction execution unit 34 of the auction apparatus 30 extracts the item ID and the delivery information from the successful bidder information received from the information terminal 12-2, and transmits the delivery request including the item ID and the delivery information thus extracted to the kept item management apparatus 20 via the communication line 13 (S118).

Subsequently, the delivery instruction unit 26 of the kept item management apparatus 20 refers to the item information storage unit 21 on the basis of the item ID included in the received delivery request, and extracts information about the storage location associated with the item ID. Then, the delivery instruction unit 26 incorporates information about the extracted storage location into the delivery request, and transmits the delivery request including the item ID, the delivery information, and information about the storage location to the server of the delivery company via the communication line 13 (S119).

Subsequently, the delivery company collects an item corresponding to the item ID included in the delivery request from the warehouse at the storage location corresponding to the information included in the delivery request received by the server (S120). Then, the delivery company delivers the retrieved item to the shipping destination indicated by the delivery information included in the delivery request (S121). The bidder pays the bid price to the user 11-1 who is a seller for the item which the bidder has won (S122).

The first embodiment of the present invention has been hereinabove explained.

As is evident from the above explanation, according to the auction system 10 according to the present embodiment, the user's burden associated with the selling work in the auction can be reduced.

### Second Embodiment

Subsequently, the second embodiment of the present invention will be hereinafter explained with reference to drawings.

In the present embodiment, an owned item designated by the user is registered for disclosure, and in a case where this corresponds to a condition registered as an item desired by another user, the owner of the item is notified of the user who wants to obtain the item, so that the owner is promoted to sell the item in the auction. On the other hand, information about the item registered for disclosure is disclosed to the user who wants the item.

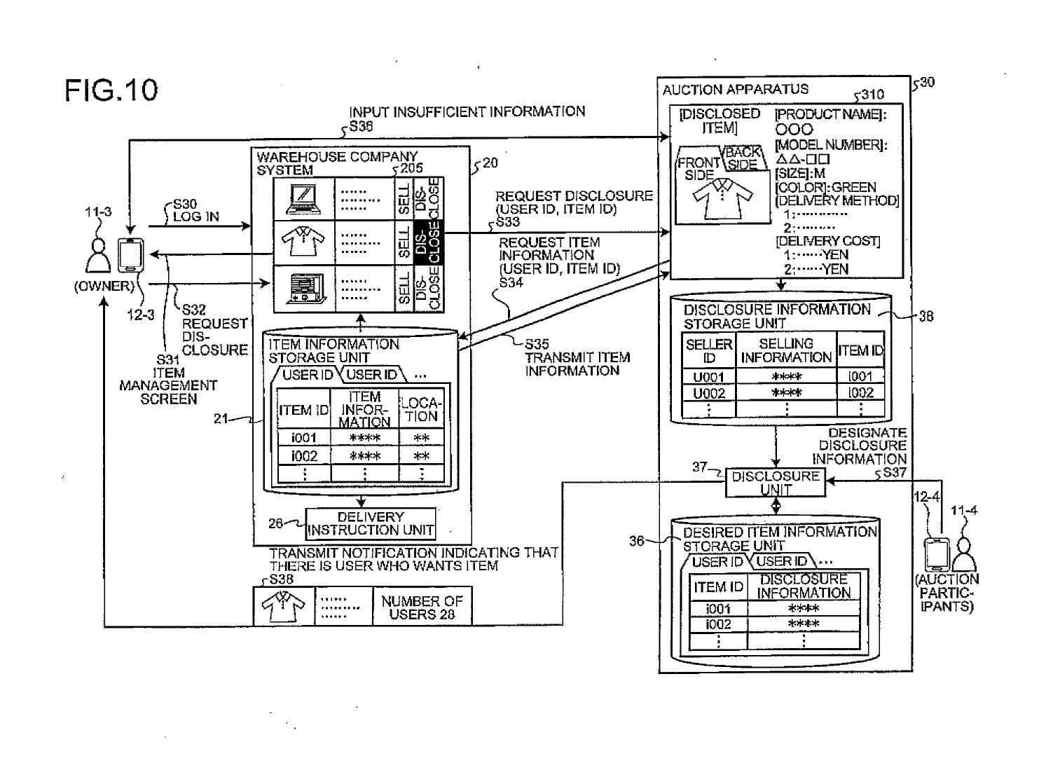

FIG. 10 is a conceptual diagram for explaining an example of concept of processing in the second embodiment. Except the features explained below, the elements in FIG. 10 denoted with the same reference numerals as those of FIG. 1 have the same or similar functions as those in FIG. 1, and therefore, explanation thereabout is omitted.

As a presumption of the present embodiment, it is supposed that a user 11-3 deposits one or more owned items with a warehouse managed by a warehouse company. The user 11-3 is registered as a user who deposits the items with the warehouse in a kept item management apparatus 20.

First, the user 11-3 uses an information terminal 12-3 to log in to a kept item management apparatus 20 (S30). The kept item management apparatus 20 authenticates the user 11-3, and obtains the item information about each item associated with the user ID of the user 11-3 from an item information storage unit 21. Then, the kept item management apparatus 20 generates data of an item management screen 205 in which item information, a selling button, and a disclosure button are associated for each of the items, and transmits the data to the information terminal 12-3 of the user 11-3 (S31).

The user 11-3 refers to the item management screen 205 displayed on the information terminal 12-3, and manages the owned items. Then, when the displayed item management screen 205 includes an item which the user 11-3 may sell if a price is put on the item, the user 11-3 operates the information terminal 12-3 to select the disclosure button associated with the item. When the disclosure button is selected, the information terminal 12-3 transmits a disclosure request including the item ID of the item associated with the selected disclosure button to the kept item management apparatus 20 (S32).

When the kept item management apparatus 20 receives the disclosure request from the information terminal 12-3, the kept item management apparatus 20 generates a disclosure request including the item ID included in the disclosure request and the user ID of the user 11-3 of the information terminal 12-3, and transmits the generated disclosure request to the auction apparatus 30 (S33). Thereafter, the service received by the user proceeds from the warehouse company service provided by the kept item management apparatus 20 to the auction service provided by the auction apparatus 30.

When the auction apparatus 30 receives the disclosure request from the kept item management apparatus 20, the auction apparatus 30 obtains the item ID from the disclosure request, and generates an item information request including the obtained item ID and transmits the item information request to the kept item management apparatus 20 (S34).

When the kept item management apparatus 20 receives the item information request from the auction apparatus 30, the kept item management apparatus 20 obtains the item information associated with the item ID included in the item request from the item information storage unit 21. Then, the kept item management apparatus 20 transmits the obtained item information to the auction apparatus 30 (S35).

The auction apparatus 30 stores, in advance, a template defining the items of the selling information required in the auction for selling. The auction apparatus 30 extracts information required for each item in the template from among the item information received from the kept item management apparatus 20, and sets the information in the corresponding item, thus generating the disclosure information. At this occasion, information unique to the auction and, not included in the item information, e.g., the start price and the duration, is not set in the disclosure information.

Then, the auction apparatus 30 generates a disclosure screen 310 for displaying the generated disclosure information. Then, the auction apparatus 30 transmits the generated disclosure screen 310 to the information terminal 12-3 of the user 11-3, thereby requesting the user 11-3 to input information which the user 11-3 wants to add for the disclosure (S36). At this occasion, the user 11-3 may delete the unnecessary information from the disclosure information for the disclosure.

After additional information is complemented and unnecessary information is deleted by the user 11-3, the auction apparatus 30 stores the disclosure information to a disclosure information storage unit 38 in such a manner that the disclosure information is associated with the user ID. Then a disclosure unit 37 discloses the disclosure information stored in the disclosure information storage unit 38 to participants of the auction. A user 11-4 who is an auction participant operates the information terminals 12-4 to search for disclosure information corresponding to a desired item. When such disclosure information is found, the user 11-4 operates the information terminals 12-4 to transmit information designating the disclosure information to the auction apparatus 30 (S37). It should be noted that the disclosure information is information which is generated in order for the owner of the item to disclose information about the item, and the disclosure information is different from the selling information indicating the information about the item sold in the auction. Therefore, even if the user 11-4 who is an auction participant operates the information terminals 12-4 to successfully find the disclosure information corresponding to the desired item, the user 11-4 cannot bid from the disclosure information.

When the disclosure unit 37 receives the information designating the disclosure information from the information terminal 12-4, the disclosure unit 37 associates the disclosure information designated by the received information with the user ID of the user 11-4 of the information terminal 12-4, and stores the disclosure information designated by the received information to a desired item information storage unit 36.

After the disclosure information is stored to the desired item information storage unit 36, the disclosure unit 37 transmits a notification indicating that there is a user who wants the item related to the disclosure information to the information terminal 12-3 of the user 11-3 who disclosed the item (S38). This notification may include information such as the disclosure information designated by the user 11-4 and information about the number of users designating the disclosure information.

Therefore, the user 11-3 who discloses information about the owned item can find that there is a user who wants that item. In this case, when selling in the auction, selling fees may be charged. In such case, if the item is sold in the auction, but nobody buys the item, then there would be a loss equivalent to the selling fees.

For this reason, in many cases, the owner is not willing to sell, in the auction, items which are not clear as to whether there is any user who wants them, e.g., an old good, a good given by somebody, and a good of which value is unknown. However, if the owner already knows that there is a user who wants an item, there is a higher chance of selling the item at a price higher than the selling fees and making profit. Therefore, the auction system 10 according to the present embodiment can provide an environment which allows an owner of an item to easily sell the item in an auction.

If there are many users who want the item, the users complete the bid price with each other, and the highest bid price may be relatively high. On the other hand, when there are a few users who want the item, there would be less competition in the bid price, and the highest bid price may be relatively low.

For this reason, when the disclosure unit 37 notifies the owner of the number of users who want the item related to the disclosure information, the owner can find the best timing for selling the item when the highest bid price becomes more expensive. Accordingly, the seller is provided with useful information for determining when is the best time to sell the item at a higher price in the auction. Therefore, this can increase the number of items sold in the auction and increase the number of users who sell in the auction.

The detailed configuration for achieving the mechanism explained above will be hereinafter explained.

The configuration of the kept item management apparatus 20 of the present embodiment is the same as the kept item management apparatus 20 according to the first embodiment except the features explained below, and therefore, repeated explanation thereabout is omitted.

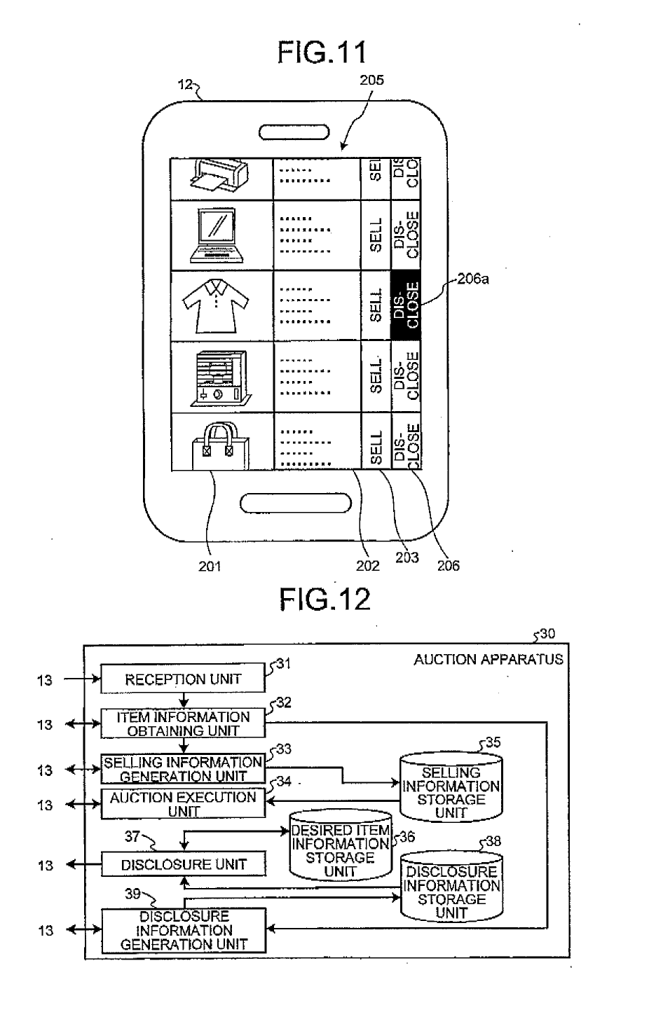

When the management screen generation unit 22 receives the user ID from the authentication processing unit 23, the management screen generation unit 22 identifies the item table 211 associated with the user ID by referring to the item information storage unit 21 on the basis of the received user ID. Then, the authentication processing unit 23 refers to the identified item table 211 to extract the item information for each item ID, and generates the item management screen 205 as shown in FIG. 11, for example. Then, the management screen generation unit 22 transmits the data of the generated item management screen 205 to the information terminal 12 via the communication line 13.

FIG. 11 illustrates an example of the item management screen 205 generated by the management screen generation unit 22 according to the second embodiment. For example, as shown in FIG. 11, the item management screen 205 includes, for each item corresponding to an item ID, an image 201 of the item, detailed information 202 about the item, a selling button 203, and a disclosure button 206. FIG. 11 illustrates an example where the item management screen 205 is displayed on the information terminal 12.

While the information terminal 12 is displaying the item management screen 205, the user 11 of the information terminal 12 operates the information terminal 12 and selects a disclosure button 206 of any one of the items (for example, a disclosure button 206a). In this case, the information terminal 12 transmits a disclosure request, which includes the item ID associated with the disclosure button 206, to the kept item management apparatus 20 via the communication line 13.

When the request transmission unit 24 receives the disclosure request from the information terminal 12, the user ID received from the authentication processing unit 23 is incorporated into the received disclosure request. Then, the request transmission unit 24 transmits the disclosure request including the user ID and the item ID to the auction apparatus 30 via the communication line 13.

FIG. 12 illustrates an example of a functional configuration of the auction apparatus 30 according to the second embodiment. The auction apparatus 30 according to the present embodiment includes a reception unit 31, an item information obtaining unit 32, a selling information generation unit 33, an auction execution unit 34, a selling information storage unit 35, a desired item information storage unit 36, a disclosure unit 37, a disclosure information storage unit 38, and a disclosure information generation unit 39.

It should be noted that, for example, the auction apparatus 30 according to the present embodiment is achieved by adding the functions to the auction apparatus 30 according to the first embodiment. Except the features explained below, the elements in FIG. 12 denoted with the same reference numerals as those of FIG. 6 have the same or similar functions as those in FIG. 6, and therefore, explanation thereabout is omitted.

When the reception unit 31 receives the disclosure request from the kept item management apparatus 20 via the communication line 13, the reception unit 31 extracts the user ID and the item ID from the received disclosure request, and sends the user ID and the item ID thus extracted to the item information obtaining unit 32.

When the item information obtaining unit 32 obtains the item information from the kept item management apparatus 20 on the basis of the item ID received from the reception unit 31, the item information obtaining unit 32 sends the received item information as well as the user ID and the item ID to the selling information generation unit 33 and the disclosure information generation unit 39.

The disclosure unit 37 discloses the disclosure information stored in the disclosure information generation unit 39 to the participants of the auction. A participant of the auction operates the information terminal 12 to search for the disclosure information related to the desired item from among the disclosure information. Then, when the participant of the auction finds the disclosure information related to the desired item, the participant of the auction operates the information terminal 12 to transmit information designating the disclosure information (for example, the item ID) to the auction apparatus 30. When the disclosure unit 37 receives the information designating the disclosure information from the information terminal 12 of the participant of the auction, the disclosure unit 37 associates the disclosure information designated by the received information with the user ID of the user 11 of the information terminal 12, and registers the disclosure information with the desired item information storage unit 36.

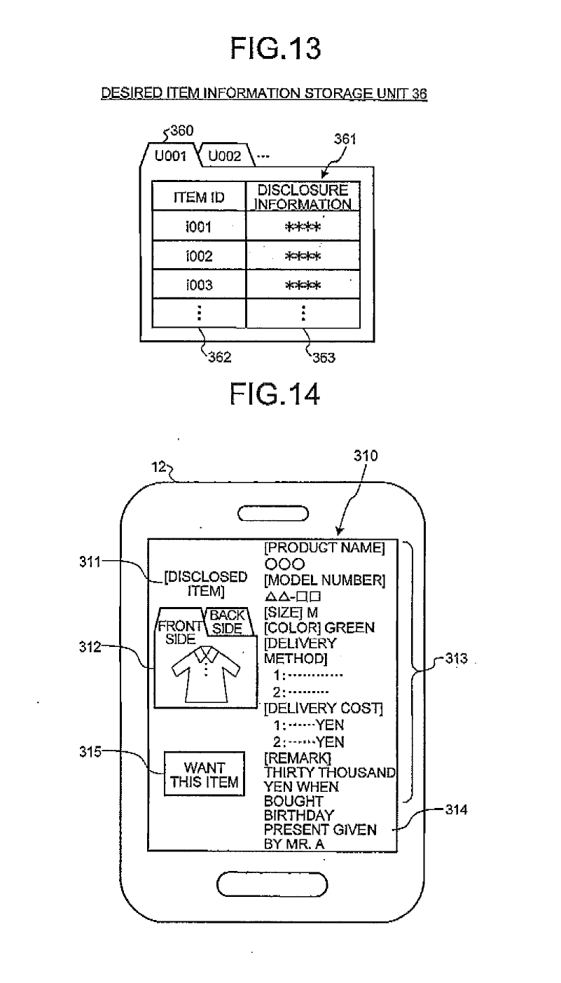

FIG. 13 illustrates an example of a structure of data stored in the desired item information storage unit 36. For example, as shown in FIG. 13, the desired item information storage unit 36 stores the desired item table 361 for each user ID 360 identifying the participant of the auction. Each desired item table 361 stores disclosure information 363 related to the desired item in association with the item ID 362 identifying each desired item.

The disclosure information generation unit 39 stores, in advance, a template having items of information which are to be included in the disclosure information. When the user ID, the item ID, and the item information are received from the item information obtaining unit 32, the disclosure information generation unit 39 extracts information which is to be set, in each item in the template from among the received item information, and sets the information in the corresponding item, thus generating the disclosure information.

Then, the disclosure information generation unit 39 generates a disclosure screen including the generated disclosure information. Then, the disclosure information generation unit 39 transmits data of the generated disclosure screen via the communication line 13 to the information terminal 12 of the user 11 corresponding to the user ID received from the item information obtaining unit 32. FIG. 14 illustrates an example of the disclosure screen 310 generated by the disclosure information generation unit 39. FIG. 14 illustrates a state where the disclosure screen 310 is displayed on the information terminal 12.

For example, as shown in FIG. 14, the disclosure screen 310 includes an area 311 displaying information indicating not auction, an area 312 displaying an image of an item, an area 313 displaying detailed information about the item to be disclosed, and an area 315 displaying a button that is selected in a case where the user wants the item related to the disclosure information.

The image of the item displayed in the area 312 and the detailed information displayed in the area 313 are extracted from the item information obtained by the item information obtaining unit 32. The detailed information about the item displayed in the area 314 may include private information, which is known to only the owner of the item, like the information displayed in the area 314, for example. The disclosure screen 310 does not include any information unique to the auction such as the start price and the duration. The button displayed in the area 315 is associated with the item ID of the item related to the disclosure information included in the disclosure screen 310.

The disclosure information generation unit 39 transmits the generated disclosure screen 310 to the information terminal 12 and causes the generated disclosure screen 310 to be displayed by the information terminal 12, so that when the user 11 of the information terminal 12 has information which is to be added when the owned item is disclosed to another user, then the user 11 is requested to complement the information.

In the disclosure screen 310 displayed on the screen of the information terminal 12, the user 11 of the information terminal 12 operates the information terminal 12 to complement information which is to be added in the area 313 and delete unnecessary information. Then, the information terminal 12 transmits data of the disclosure screen 310, in which additional information has been complemented and unnecessary information has been deleted, to the kept item management apparatus 20 via the communication line 13.

When the disclosure information generation unit 39 receives the data of the disclosure screen 310, in which additional information has been complemented and unnecessary information has been deleted, from the information terminal 12, the disclosure information generation unit 39 extracts the disclosure information from the received disclosure screen 310, and stores the extracted disclosure information to the disclosure information storage unit 38.

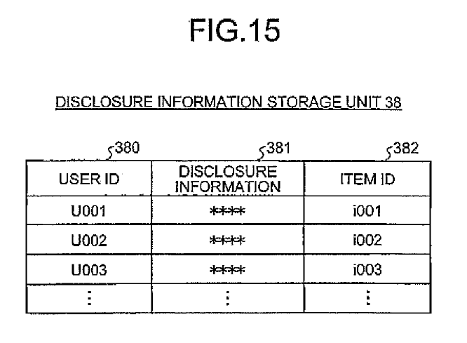

FIG. 15 illustrates an example of a structure of data stored in the disclosure information storage unit 38. For example, as shown in FIG. 15, the disclosure information storage unit 38 stores the disclosure information 381 of the item and the item ID 382 of the item in association with the user ID 380 identifying each user 11 disclosing items.

When the disclosure information generation unit 39 receives the data of the disclosure screen 310, in which additional information has been complemented and unnecessary information has been deleted, from the information terminal 12, the disclosure information generation unit 39 associates, with the user ID of the user 11 of the information terminal 12, the disclosure information which is included in the disclosure screen 310 received from the information terminal 12 and in which additional information has been complemented and unnecessary information has been deleted by the user 11 of the information terminal 12, and stores the disclosure information as well as the item ID.

The disclosure unit 37 discloses the disclosure information stored in the disclosure information storage unit 38 to the participant of the auction in such a manner that the disclosure information is associated with the item ID. When the disclosure unit 37 receives information designating disclosure information (for example, an item ID) from the information terminal 12 of the participant of the auction, the disclosure unit 37 obtains the disclosure information corresponding to the received item ID from the disclosure information storage unit 38.

Subsequently, the disclosure unit 37 stores the obtained disclosure information as well as the corresponding item ID to the desired item information storage unit 36 in such a manner that the disclosure information is associated with the user ID of the user 11 of the information terminal 12 transmitted information designating the disclosure information. Then, the disclosure unit 37 transmits a notification indicating that there is a user who wants the item related to the corresponding disclosure information to the information terminal 12 of the user 11 who disclosed the item.

It should be noted that the notification transmitted to the information terminal 12 of the user 11 who disclosed the item preferably includes information about at least a portion of the disclosure information related to the item (for example, the image, the product name of the disclosed item, and the like). It should be noted that the notification preferably includes information indicating the number of users who want the item related to the disclosure information because of which the notification was transmitted. At this occasion, in a case where the disclosure unit 37 stores, for example, the disclosure information to the desired item information storage unit 36, the disclosure unit 37 refers to the desired item information storage unit 36, and calculates, as the number of users, the number of user IDs associated with the same disclosure information as the stored disclosure information, and incorporates the number of users to the notification. By referring to the number of users who want the item related to the disclosure information, the discloser of the item can roughly find an approximate number of users who want the item of the corresponding disclosure information.

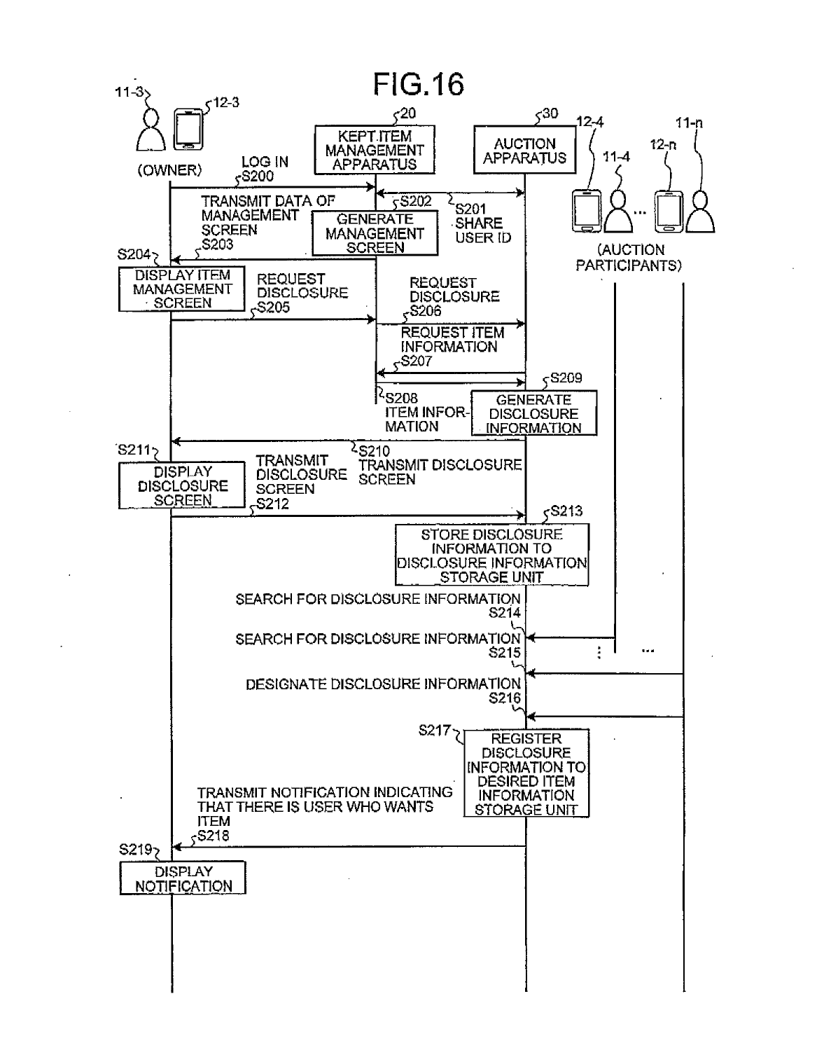

Subsequently, overall operation of the auction system 10 according to the present embodiment will be explained with reference to FIG. 16. FIG. 16 is a sequence diagram illustrating an example of operation of the auction system 10 according to the second embodiment.

First, when the user 11-3 who is the owner of the item operates the information terminal 12-3 and logs in to the kept item management apparatus 20 (S200). When the authentication processing unit 23 in the kept item management apparatus 20 successfully authenticates the information terminal 12-3, the authentication processing unit 23 sends the user ID of the user 11-3 of the information terminal 12-3 to the management screen generation unit 22 and the request transmission unit 24. In addition, the authentication processing unit 23 shares the user ID of the user 11-3, who is successfully authenticated, with the auction apparatus 30 (S201).

The management screen generation unit 22 of the kept item management apparatus 20 refers to the item information storage unit 21 on the basis of the user ID received from the authentication processing unit 23, and identifies an item table 211 associated with the user ID. Then, the authentication processing unit 23 refers to the identified item table 211 to extract the item information for each item ID, and generates the item management screen 205 explained in FIG. 11, for example (S202). Then, the management screen generation unit 22 transmits data of the generated item management screen 205 to the information terminal 12-3 via the communication line 13 (S203).

The information terminal 12-3 displays the item management screen 205 on the screen on the basis of the data received from the kept item management apparatus 20 (S204). Then, when the information terminal 12-3 receives selection of a disclosure button from the user 11-3, the information terminal 12-3 transmits a disclosure request including the item ID associated with the disclosure button to the kept item management apparatus 20 via the communication line 13 (S205).

Subsequently, the request transmission unit 24 of the kept item management apparatus 20 incorporates the user ID received from the authentication processing unit 23 into the disclosure request received from the information terminal, 12-3. Then, the request transmission unit 24 transmits the disclosure request including the user ID and the item ID to the auction apparatus 30 via the communication line 13 (S206).

Subsequently, the reception unit 31 of the auction apparatus 30 extracts the user ID and the item ID from the disclosure request received from the kept item management apparatus 20, and sends the user ID and the item ID thus extracted to the item information obtaining unit 32 in the auction apparatus 30. The item information obtaining unit 32 generates an item information request including the item ID received from the reception unit 31, and transmits the generated item information request to the kept item management apparatus 20 via the communication line 13 (S207).

The item information transmission unit 25 in the kept item management apparatus 20 refers to the item information storage unit 21 in the kept item management apparatus 20 on the basis of the item ID included in the received item information request, and extracts the item information associated with the item ID. Then, the item information transmission unit 25 transmits the extracted item information to the auction apparatus 30 via the communication line 13 (S208).

When the request transmission unit 24 receives the disclosure request from the information terminal 12-3 in step S206, the request transmission unit 24 may cause the item information transmission unit 25 to extract the item information corresponding to the item ID included in the disclosure request. Then, the request transmission unit 24 may further include the item information extracted by the item information transmission unit 25 into the disclosure request, and may transmit the disclosure request including the user ID, the item ID, and the item information to the auction apparatus 30 via the communication line 13.

Subsequently, the item information obtaining unit 32 of the auction apparatus 30 sends the item information received from the kept item management apparatus 20 as well as the user ID and the item ID to the selling information generation unit 33 and the disclosure information generation unit 39. The disclosure information generation unit 39 extracts information which is to be set in each item in the template of the disclosure information from the item information received from the item information obtaining unit 32, and sets the information in the corresponding items, thus generating the disclosure information (S209).

Subsequently, the disclosure information generation unit 39 generates the disclosure screen 310 including the generated disclosure information. Then, the disclosure information generation unit 39 transmits data of the generated disclosure screen 310 via the communication line 13 to the information terminal 12-3 of the user 11-3 corresponding to the user ID received from the item information obtaining unit 32 (S210). The information terminal 12-3 displays the disclosure screen 310 on the screen on the basis of the received data (S211).

Subsequently, the user 11-3 of the information terminal 12-3 refers to the disclosure screen 310 displayed on the screen of the information terminal 12-3 to confirm additional information and unnecessary information, and operates the information terminal 12-3 to perform operation for complementing additional information and deleting unnecessary information. The information terminal 12-3 transmits the data of the disclosure screen 310, in which additional information has been complemented and unnecessary information has been deleted, to the auction apparatus 30 via the communication line 13 (S212).

Subsequently, the disclosure information generation unit 39 associates, with the user ID of the user 11-3 of the information terminal 12-3, the disclosure information which is included in the disclosure screen 310 received from the info nation terminal 12-3 and in which additional information has been complemented and unnecessary information has been deleted by the user 11-3, and stores the disclosure information as well as the item ID to the disclosure information storage unit 38 (S213). Then, the disclosure unit 37 discloses the disclosure information stored in the disclosure information storage unit 38 to the participants of the auction in such a manner that the disclosure information is associated with the item ID.

Subsequently, the users 11-4 to n who participate in the auction operate the information terminals 12-4 to n to search for disclosure information corresponding to desired items (S214, S215). When such disclosure information is found, the user 11-n operates the information terminal 12-n to select a predetermined button displayed on the screen including the disclosure information, and transmits information designating the disclosure information (for example, an item ID) to the auction apparatus 30 (S216). The disclosure unit 37 obtains the disclosure information corresponding to the received item ID from the disclosure information storage unit 38, and stores the obtained disclosure information to the desired item information storage unit 36 in such a manner that the disclosure information is associated with the user ID of the user 11-n of the information terminal 12-n that transmitted the item ID (S217).

After the disclosure information is stored to the desired item information storage unit 36, the disclosure unit 37 transmits a notification indicating that there is a user who wants the item related to the disclosure information to the information terminal 12-3 of the user 11-3 who disclosed the item (S218). Then, the information terminal 12-3 displays the received notification on the screen (S219).

The second embodiment of the present invention has been hereinabove explained.

### Third Embodiment

Subsequently, the third embodiment of the present invention will be hereinafter explained with reference to drawings.

The present embodiment is different from the second embodiment in that a user does not have to deposit an owned item to a warehouse company.

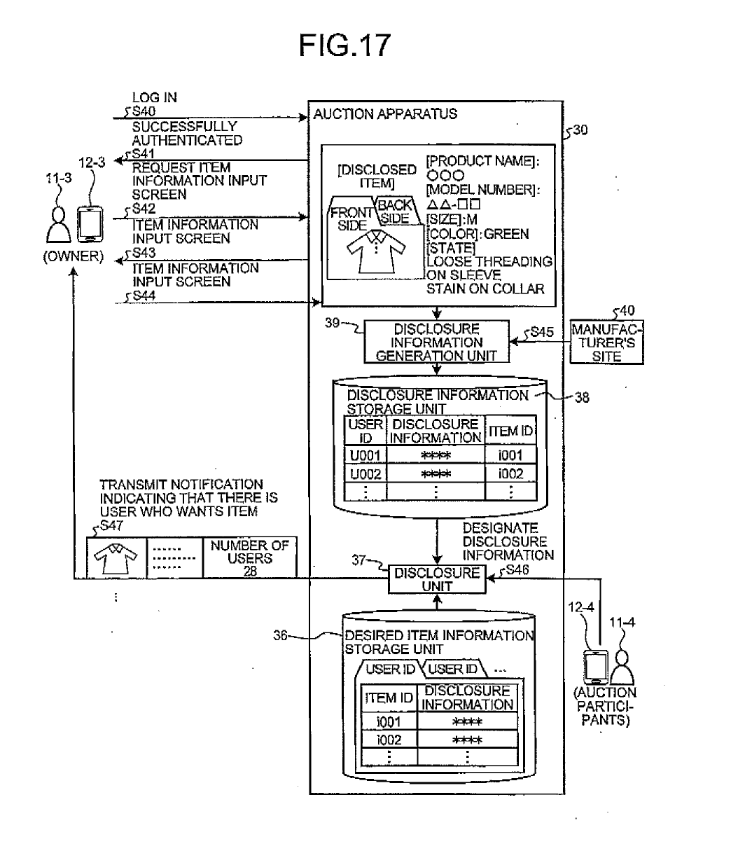

FIG. 17 is a conceptual diagram for explaining an example of concept of processing according to the third embodiment. Except the features explained below, the elements in FIG. 17 denoted with the same reference numerals as those of FIG. 10 have the same or similar functions as those in FIG. 10, and therefore, explanation thereabout is omitted.

First, a user 11-3 uses an information terminal 12-3 to log in to an auction apparatus 30 (S40). When the user 11-3 is successfully authenticated, the auction apparatus 30 transmits the success of the authentication to an information terminal 12-3 (S41). Subsequently, the user 11-3 operates the information terminal 12-3 to request the auction apparatus 30 for an input screen of item information (S42). The auction apparatus 30 transmits data of the item information input screen to the information terminal 12-3 (S43).

The user 11-3 operates the information terminal 12-3 to input item information such as the image of the item, the product name of the item, and the like into the item information input screen displayed on the screen of the information terminal 12-3. Then, the information terminal 12-3 transmits data of the item information input screen including the received item information to the auction apparatus 30 (S44).

A disclosure information generation unit 39 of the auction apparatus 30 generates the disclosure information on the basis of the item information included in the data of the item information input screen received from the information terminal 12-3. At this occasion, if the disclosure information generation unit 39 can obtain detailed information about the item from a manufacturer's site 40 and the like on the basis of a model number, a JAN code, and the like of the item, the disclosure information generation unit 39 also uses the information to generate the disclosure information (S45). Then, the disclosure information generation unit 39 stores the generated disclosure information to the disclosure information storage unit 38 in association with the user ID.

Then, the disclosure unit 37 publishes the disclosure information stored in the disclosure information storage unit 38 to the participants of the auction. A user 11-4 of the auction participant operates an information terminal 12-4 to search for the disclosure information corresponding to the desired item. When such disclosure information is found, the user 11-4 operates the information terminal 12-4 to transmit the information designating the disclosure information to the auction apparatus 30 (S46).

When the disclosure unit 37 receives the information designating the disclosure information from the information terminal 12-4, the disclosure unit 37 stores the disclosure information designated by the received information to the desired item information storage unit 36 in such a manner that the disclosure information is associated with the user ID of the user 11-4 of the information terminal 12-4.

After the disclosure information is stored to the desired item information storage unit 36, the disclosure unit 37 transmits a notification indicating that there is a user who wants the item related to the corresponding disclosure information to the information terminal 12-3 of the user 11-3 who disclosed the item (S47). This notification may include information such as the disclosure information designated by the user 11-4 and information about the number of users designating the disclosure information.

The detailed configuration for achieving the mechanism explained above will be hereinafter explained.

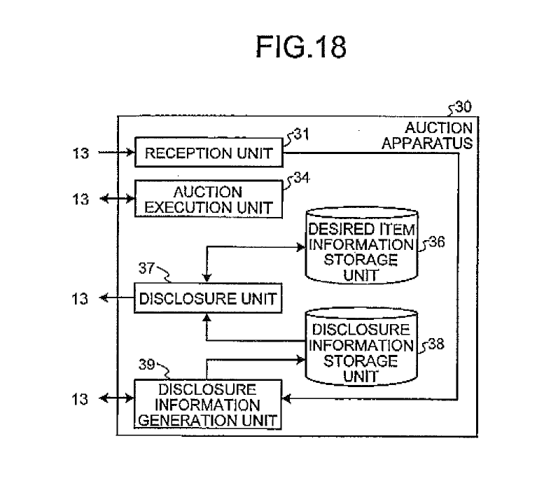

FIG. 18 illustrates an example of a functional configuration of the auction apparatus 30 according to the third embodiment. The auction apparatus 30 according the present embodiment includes a reception unit 31, an auction execution unit 34, a desired item information storage unit 36, a disclosure unit 37, a disclosure information storage unit 38, and a disclosure information generation unit 39. Except the features explained below, the elements in FIG. 18 denoted with the same reference numerals as those of FIG. 12 have the same or similar functions as those in FIG. 12, and therefore, explanation thereabout is omitted.

When logged in by the information terminal 12 via the communication line 13, the reception unit 31 authenticates the user 11 of the information terminal 12, and transmits an authentication result to the information terminal 12. Then, when an item information input screen is requested from the information terminal 12 of the user 11 who has been successfully authenticated, the reception unit 31 transmits data of the item information input screen to the information terminal 12.

Then, when the data of the item information input screen into which the item information has been input are received from the information terminal 12, the reception unit 31 extracts the item information from the data of the received item information input screen, and allocates the item ID to the item identified by the extracted item information. Then, the reception unit 31 sends the item information and the item ID as well as the user ID of the user 11 of the information terminal 12 to the disclosure information generation unit 39.

The disclosure information generation unit 39 stores, in advance, a template having items of information which are to be included in the disclosure information. When the disclosure information generation unit 35 receives the user ID, the item ID, and the item information from the reception unit 31, the disclosure information generation unit 39 extracts information for setting in each item in the template from the received item information, and sets the information in the corresponding items, thus generating the selling information.

At this occasion, if the disclosure information generation unit 39 can obtain detailed information about the item via the communication line 13 from the manufacturer's site 40 and the like on the basis of a model number, a JAN code, and the like of the item included in the item information, the disclosure information generation unit 39 also uses the information to generate the disclosure information.

Then, the disclosure information generation unit 39 generates a disclosure screen including the generated disclosure information. Then, the disclosure information generation unit 39 associates the data of the generated disclosure screen with the user ID and the item ID received from the reception unit 31, and stores the data of the generated disclosure screen to the disclosure information storage unit 38.

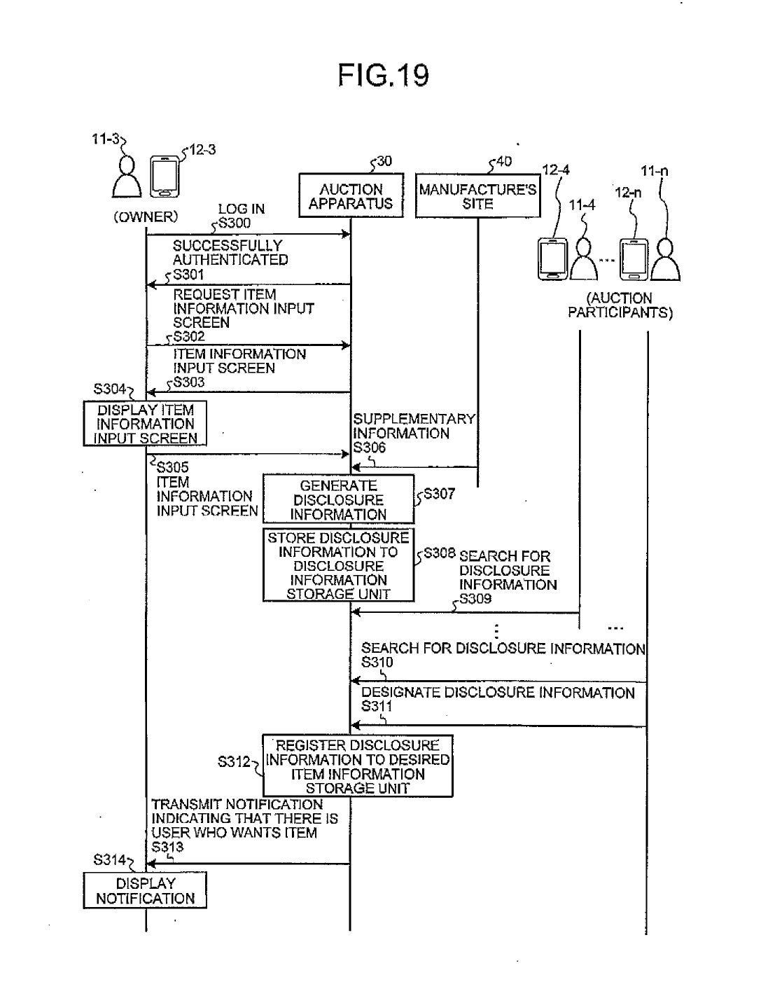

Subsequently, overall operation of an auction system 10 in the present embodiment will be explained with reference to FIG. 19. FIG. 19 is a sequence diagram illustrating an example of operation of the auction system 10 according to the third embodiment.

First, the user 11-3 who is the owner of the item operates the information terminal 12-3 to log in to the auction apparatus 30 (S300). When the reception unit 31 in the auction apparatus 30 successfully authenticates the information terminal 12-3, the reception unit 31 transmits information indicating the success of the authentication to the information terminal 12-3 (S301).

Subsequently, the use 11-3 who has been successfully authenticated operates the information terminal 12-3 to request the auction apparatus 30 for an item information input screen (S302). The reception unit 31 transmits the data of the item information input screen to the information terminal 12-3 (S303).

The information terminal 12-3 displays the item information input screen on the screen on the basis of the data received from the auction apparatus 30 (S304). Then, when the user 11-3 finishes input of item information, the information terminal 12-3 transmits the data of the item information input screen, into which the item information has been input, to the auction apparatus 30 (S305). The reception unit 31 extracts the item information from the data of the received item information input screen, and allocates the item ID to the item identified by the extracted item information. Then, the reception unit 31 sends the item information and the item ID as well as the user ID of the user 11-3 of the information terminal 12-3 to the disclosure information generation unit 39.

Subsequently, the disclosure information generation unit 39 of the auction apparatus 30 obtains supplementary information about the item from the manufacturer's site 40 and the like via the communication line 13 on the basis of information about a model number, a JAN code, and the like of the item included in the item information received from the reception unit 31 (S306). Then, the disclosure information generation unit 39 extracts information which is to be set in each item in the template of the disclosure information from the item information received from the reception unit 31 and the supplementary information obtained from the manufacturer's site 40, and sets the information in the corresponding items, thus generating the disclosure information (S307).

Subsequently, the disclosure information generation unit 39 associates the generated disclosure information with the user ID and the item ID received from the reception unit 31, and stores the generated disclosure information to the disclosure information storage unit 38 (S308). Thereafter, the processing shown in steps S309 to S314 is the same processing as that in steps S214 to S219 explained with reference to FIG. 16, and therefore, explanation is omitted.

The third embodiment of the present invention has been hereinabove explained.

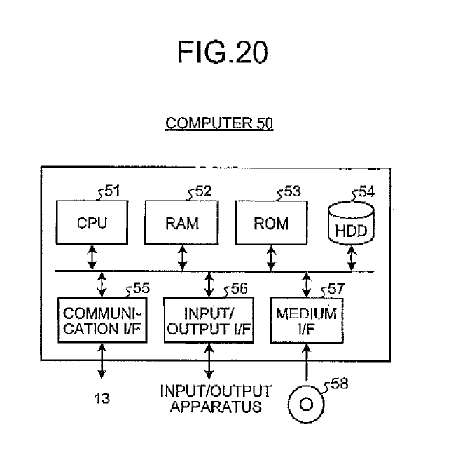

It should be noted that the auction apparatus 30 according to the first or second embodiment is achieved by, for example, a computer 50 having a configuration as shown in FIG. 20. FIG. 20 is a hardware configuration diagram illustrating an example of the computer 50 achieving the function of the auction apparatus 30. The computer 50 includes a CPU (Central Processing Unit) 51, a RAM (Random Access Memory) 52, a ROM (Read Only Memory) 53, an HDD (Hard Disk Drive) 54, a communication interface (I/F) 55, an input/output interface (I/F) 56, and a medium interface (I/F) 57.

The CPU 51 operates on the basis of a program stored in the ROM 53 or the HDD 54, and performs control of each unit. The ROM 53 stores a boot program executed by the CPU 51 when the computer 50 is activated, a program depending on hardware of the computer 50, and the like.

The HDD 54 stores the program executed by the CPU 51, the data used by the program, and the like. The communication interface 55 receives the data from other equipment via the communication line 13, and sends the data to the CPU 51, and transmits the data generated by the CPU 51 to other equipment via the communication line 13.

The CPU 51 controls output apparatuses such as a display and a printer and input apparatuses such as a keyboard and a mouse via the input/output interface 56. The CPU 51 obtains the data from the input apparatus via the input/output interface 56. The CPU 51 outputs the generated data via the input/output interface 56 to the output apparatus.

The medium interface 57 reads the program or the data stored in a recording medium 58, and provides the program or the data to the CPU 51 via the RAM 52. The CPU 51 loads the program via the medium interface 57 from the recording medium 58 to the RAM 52, and executes the loaded program. The recording medium 58 is, for example, an optical recording medium such as a DVD (Digital Versatile Disc) and a PD (Phase change rewritabie Disk), a magneto-optical recording medium such as an MO (Magneto-Optical disk), a tape medium, a magnetic recording medium, or a semiconductor memory.

When the computer 50 functions as the auction apparatus 30 according to the first embodiment, the CPU 51 of the computer 50 executes the program loaded to the RAM 52, thus achieving the functions of the reception unit 31, the item information obtaining unit 32, the selling information generation unit 33, the auction execution unit 34, and the selling information storage unit 35. The HDD 54 stores the data in the selling information storage unit 35.

When the computer 50 functions as the auction apparatus 30 according to the second embodiment, the CPU 51 of the computer 50 executes the program loaded to the RAM 52, thus achieving the functions of the reception unit 31, the item information obtaining unit 32, the selling information generation unit 33, the auction execution unit 34, the selling information storage unit 35, the desired item information storage unit 36, the disclosure unit 37, the disclosure information storage unit 38, and the disclosure information generation unit 39. The HDD 54 stores data in the selling information storage unit 35, the desired item information storage unit 36, and the disclosure information storage unit 38.

When the computer 50 functions as the auction apparatus 30 according to the third embodiment, the CPU 51 of the computer 50 executes the program loaded to the RAM 52, thus achieving the functions of the reception unit 31, the auction execution unit 34, the desired item information storage unit 36, the disclosure unit 37, the disclosure information storage unit 38, and the disclosure information generation unit 39. The HDD 54 stores data in the desired item information storage unit 36 and the disclosure information storage unit 38.

The CPU 51 of the computer 50 reads the programs from the recording medium 58 and executes the programs. Alternatively, in another example, these programs may be obtained from another apparatus via the communication line 13.

In the above second embodiment, when a matching notification is received and thereafter an item identified by the disclosure info nation included in the matching notification is sold in an auction, the item information obtaining unit 32 of the auction apparatus 30 may extract the disclosure information from the disclosure information storage unit 38, and use information included in the extracted disclosure information to generate selling information.

In the second or third embodiment explained above, the disclosure unit 37 discloses the disclosure information to the participants of the auction, but the present invention is not limited thereto. For example, the disclosure unit 37 receives information about the item desired by a user from the use associates the information with the user ID, and accumulates the information in the desired item information storage unit 36, and when the disclosure information stored in the disclosure information storage unit 38 includes one corresponding to information about the desired item accumulated in the desired item information storage unit 36, then the disclosure information may be disclosed to only the user ID corresponding to the information about the desired item. In this case, when the disclosure unit 37 discloses the disclosure information, a message indicating that there is a user who wants the item related to the disclosure information may be notified to the owner of the item related to the disclosure information.

In the second or third embodiment explained above, when the disclosure unit 37 receives an inquiry from the user 11 who discloses the item, the disclosure unit 37 refers to the desired item info/nation storage unit 36, and may reply, as the number of users who want the item, the number of user IDs associated with the disclosure information related to the item. Therefore, the user 11 who discloses the item can find the number of people who want the item at any given timing.

When the disclosure unit 37 receives a request from the information terminal 12 of the user 11, the disclosure unit 37 refers to the desired item information storage unit 36, and transmits information about the desired item table associated with the user ID of the user 11 to the information terminal 12. When the disclosure unit 37 receives a deletion request designating the item ID from the information terminal 12, the disclosure unit 37 deletes the item ID and the disclosure information associated with the item ID from the desired item table associated with the user ID of the user 11 of the information terminal 12.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An auction apparatus comprising:
a reception unit configured to receive selling request including identification information about an item and identification information about a user who sells the item from an outside the auction apparatus;
an item information obtaining unit configured to obtain item information about an item which is owned by a user identified by the identification information included in the received selling request and which is identified by the identification information included in the received selling request from an external database which is provided outside the auction apparatus and which manages, for each user, item information about an item owned by the user when the reception unit receives the selling request;
a selling information generation unit configured to generate selling information including information required in an auction for selling using the item information obtained by the item information obtaining unit in response to the selling request; and
an auction execution unit configured to execute the auction using the generated selling information.

2. The auction apparatus according to claim 1, wherein when an item sold in response to the selling request is bought, the auction execution unit receives information about a shipping destination of the bought item from a bidder, and
the auction execution unit transmits a delivery request including identification information about the bought item and information about the shipping destination to an external management system which manages the bought item to request the management system to deliver the bought item.

3. The auction apparatus according to claim 1, wherein the selling information generation unit presents the generated selling information to a user identified by the identification information included in the selling request to request the user to delete unnecessary information and complement insufficient information for selling.

4. The auction apparatus according to claim 1, wherein the reception unit further receives a disclosure request including identification information about an item and identification information about a user who discloses the item from the outside the auction apparatus,
when the reception unit receives the disclosure request, the item information obtaining unit obtains item information about an item which is owned by a user identified by the identification information included in the received disclosure request and which is identified by the identification information included in the disclosure request from the external database, and
the auction apparatus further includes:
a disclosure information generation unit configured to generate, using item information obtained by the item information obtaining unit in response to the disclosure request, disclosure information for disclosing the item information without allowing bidding; and
a disclosure unit configured to disclose the disclosure information generated by the disclosure information generation unit in a viewable manner.

5. The auction apparatus according to claim 4, wherein when the disclosure unit receives designation of disclosure information from a user who wants the item related to the disclosure information, the disclosure unit notifies the user who disclosed the item that there is the user who wants the item.

6. The auction apparatus according to claim 4, further comprising a desired item information storage unit configured to store, for each user, disclosure information related to the item wanted by the user,
wherein when the disclosure unit receives designation of disclosure information from a user who wants the item related to the disclosure information, the disclosure unit stores the designated disclosure information to a desired item storage unit in association with identification information of the user, and
when the disclosure unit receives an inquiry from the user who discloses the item, the disclosure unit refers to the desired item storage unit, and notifies a number of users associated with the disclosure information related to the item to the user who discloses the item.

7. The auction apparatus according to claim 6, wherein when the disclosure unit receives designation of disclosure information from a user who wants the item related to the disclosure information, the disclosure unit stores the designated disclosure information to the desired item storage unit in association with identification information of the user, and thereafter refers to the desired item storage unit, and the disclosure unit identifies a number of users associated with the disclosure information related to the item, and the disclosure unit notifies the user who discloses the item of the number of users identified and that there is a user who wants the item.

8. The auction apparatus according to claim 4, wherein the selling information generation unit presents the generated disclosure information to the user identified by the identification information included in the disclosure request, thereby requesting the user to delete unnecessary information for disclosure.

9. The auction apparatus according to claim 1, wherein the item information includes information about an image of a corresponding item.

10. An auction method for causing a computer to execute:
receiving selling request including identification information about an item and identification information about a user who sells the item from an outside the computer;
obtaining, upon receiving the selling request, item information about an item which is owned by a user identified by the identification information included in the received selling request and which is identified by the identification information included in the received selling request from an external database which is provided outside the computer and which manages, for each user, item information about an item owned by the user;
generating selling information including information required in an auction for selling using item information obtained in response to the selling request; and
executing the auction using the generated selling information.

11. A non-transitory computer readable storage medium having stored therein a program causing a computer to execute a process, the process comprising:
receiving selling request including identification information about an item and identification information about a user who sells the item from an outside the computer;
obtaining, upon receiving the selling request, item information about an item which is owned by a user identified by the identification information included in the received selling request and which is identified by the identification information included in the received selling request from an external database which is provided outside the computer and which manages, for each user, item information about an item owned by the user;
generating selling information including information required in an auction for selling using item information obtained in response to the selling request; and
executing the auction using the generated selling information.

12. An auction system comprising:
an auction apparatus; and
a kept item management apparatus,
wherein the kept item management apparatus includes:
a selling request transmission unit configured to transmit, upon receiving, from a user, a selling request including identification information about an item and identification information about the user, the received selling request to the auction apparatus;
an item information storage unit configured to store, for each user, item information about an item which is owned by the user and which is deposited from the user and held in a warehouse; and
an item information transmission unit configured to obtain, upon receiving an item information request including identification information about an item and identification information about the user from the auction apparatus, item information about an item which is owned by a user identified by the identification information included in the item information request and which is identified by the identification information included in the item information request and transmit the obtained item information as well as the identification information about the item and the user included in the item information request to the auction apparatus,
wherein the auction apparatus includes:
a reception unit configured to receive the selling request from the kept item management apparatus;
an item information obtaining unit configured to transmit the item information request including the identification information about the item and the identification information about the user included in the selling request to the kept item management apparatus when the reception unit receives the selling request, and obtain item information about an item identified by the identification information included in the selling request as a response to the item information request from the kept item management apparatus;
a selling information generation unit configured to generate selling information including information required in an auction for selling using item information obtained by the item information obtaining unit in response to the selling request; and
an auction execution unit configured to execute the auction using the generated selling information.
